(19) United States
(12) Patent Application Publication
(10) Pub. No.: US 2014/0215895 A1
(43) Pub. Date: Aug. 7, 2014

(54) FISHING HOOK

(71) Applicant: Off The Hook, LLC, Bristol, IN (US)

(72) Inventor: David A. Zobrosky, Bristol, IN (US)

(73) Assignee: Off The Hook, LLC, Bristol, IN (US)

(21) Appl. No.: 14/172,421

(22) Filed: Feb. 4, 2014

Related U.S. Application Data
(60) Provisional application No. 61/761,201, filed on Feb. 5, 2013.

(51) Int. Cl. A01K 83/06

(52) U.S. Cl. CPC A01K 83/06
USPC 43/44.8

(57) ABSTRACT

A fishing hook includes a J-shaped body extending from an eyelet at a first end to a hook at a second end. A corkscrew-shaped portion is positioned intermediately between the first end and the second end. A locking arm is joined by a hinge to the fishing hook. The locking arm includes a clasp for removably grasping the fishing hook. The locking arm includes a barb extending toward the corkscrew. The fishing hook described herein allows the hook to be baited quickly and does not require that the worm be skewered by the hook.

### CROSS-REFERENCE TO RELATED APPLICATION

This application is based upon and claims the benefit of priority from the prior patent application Ser. No. 61/761,201, filed on Feb. 5, 2013, the entire contents of which are incorporated herein by reference.

### BACKGROUND OF THE INVENTION

The present disclosure relates to an improved fishing hook. Fishing hooks, in many configurations and varieties, have been present for generations. The basic design of a fishing hook includes a J-shaped member having an eyelet on one end for being secured to a fishing line, and a sharp point on the other end, preferably including a barb, for catching a fish. Traditionally, some type of bait, such as a worm, is carried on the fishing hook for luring the target fish.

While worms are good for attracting fish, their slimy skin can be off-putting to a user, especially a novice. Indeed, handling the worms can be a barrier which prevents some from participating in fishing altogether. Further, worms are typically skewered one or more times when placing them on a fishing hook, which can lead to further user displeasure. As such, an improved fishing hook is needed which allows the worm to be placed on the hook more quickly, and minimizes or eliminates the need to pierce the worm with the hook.

### SUMMARY OF THE INVENTION

The present disclosure describes an improved fishing hook. The fishing hook described herein includes a J-shaped body extending from an eyelet at a first end to a hook at a second end. A corkscrew-shaped portion is positioned intermediately between the first end and the second end. A locking arm is joined by a hinge to the fishing hook and allows the locking arm to be moved between an open position and a closed position. The locking arm includes a clasp for removably grasping the fishing hook. The locking arm includes a barb extending toward the corkscrew. The fishing hook described herein allows the hook to be baited with a worm quickly and does not require that the worm be skewered by the hook.

### BRIEF DESCRIPTION OF THE DRAWINGS

A preferred embodiment of this invention has been chosen wherein:

FIG. 1 is perspective view of the improved fishing hook;

FIG. 2 is a side view of the fishing hook of FIG. 1;

FIG. 3 is a side view of the fishing hook of FIG. 2 with a worm baited thereon and with the locking arm in the open position; and

FIG. 4 is a side view of the fishing hook of FIG. 2 with a worm baited thereon and with the locking arm in the closed position.

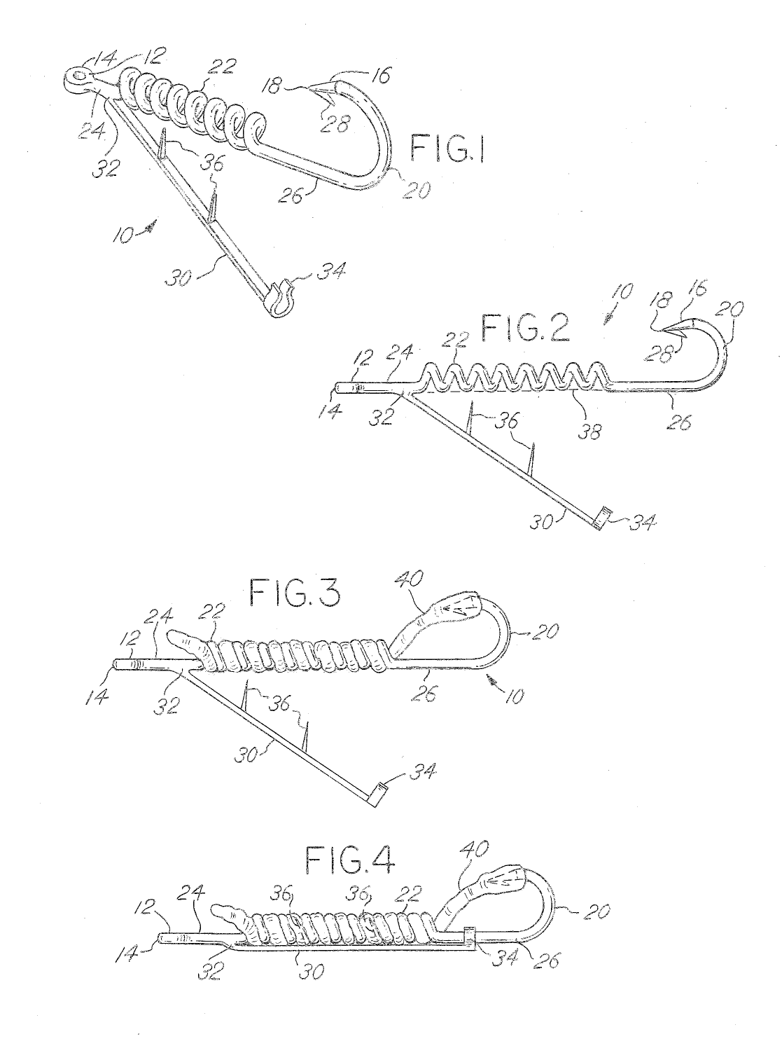

### DESCRIPTION OF THE PREFERRED EMBODIMENT

The present disclosure describes an improved fishing hook 10. The fishing hook 10 described herein is generally J-shaped and extends from an eyelet 12 at a first end 14 to a hook 16 at a second end 18. The J-shape of the fishing hook 10 is accomplished by a bend 20. The eyelet 12 is suitable for accepting a fishing line.

The fishing hook 10 includes a corkscrew 22 spaced intermediately between the first end 14 and the second end 18. The corkscrew 22 is a spiraled portion of the fishing hook 10. The corkscrew 22 is formed as a unitary member with the balance of the hook body. The corkscrew 22 is used in combination with a worm 40, wherein the worm 40 is wrapped around the corkscrew 22 when baiting the hook as described in greater detail below. This saves the user from having to repeatedly skewer the worm 40 with the hook when baiting the hook, which skewering can be unpleasant for some users.

The corkscrew 22 is spaced from the eyelet 12 by an upper span 24. The upper span 24 is a generally straight portion of the fishing hook 10 positioned between the corkscrew 22 and the eyelet 12 on the upper end of the fishing hook 10 . The corkscrew 22 is spaced from the bend 20 by a lower span 26. The lower span 26 is a generally straight portion of the fishing hook 10 positioned between the corkscrew 22 and the bend 20.

The fishing hook 10 terminates at the lower end at a hook 16. The hook 16 includes a sharp point and preferably also includes a hook barb 28. The bend 20 is defined as the portion of the fishing hook 10 between the lower span 26 and the hook 16. The bend 20 is a curve which changes the direction of the hook by 150-210 degrees, preferably 180 degrees, as is known in the art.

A locking arm 30 is connected to the fishing hook 10. The locking arm 30 is hingedly connected to the fishing hook 10. In the preferred embodiment, the locking arm 30 is joined by a living hinge 32 to the upper span 24, more preferably to the junction between the upper span 24 and the corkscrew 22. The living hinge 32 is a thin flexible hinge made from the same material as the locking arm 30 and the upper span 24. In another embodiment, the locking arm 30 is joined to the fishing hook 10 by a mechanical hinge.

The locking arm 30 is preferably a straight member extending from the living hinge 32 to a clasp 34. In one embodiment, one or more locking arm barbs 36 extend from intermediate positions along the locking arm 30. The locking arm barbs 36 extend from the locking arm 30 in the direction of the corkscrew. The locking arm 30 is movable between an open position and a closed position. The clasp 34 is shaped to grip the lower span 26; in one embodiment the clasp 34 is C-shaped and interlocks around a portion of the lower span 26. The clasp 34 serves to releasably hold the locking arm 30 in the closed position with the locking arm parallel with both the upper span 24 and the lower span 26. The open position is defined as the clasp 34 disengaged from the lower span 26 and the locking arm 30 not parallel with the upper span 24 and the lower span 26.

When the locking arm 30 is in the closed position, the locking arm barbs 36 will extend into the corkscrew 22 and will pierce the worm 40, thereby firmly holding the worm 40 to the fishing hook 10, as shown in FIG. 4.

In one embodiment, a rear plane 38 is defined by the rear-most portion of the upper span 24 and the lower span 26. In this embodiment, the corkscrew 22 does not extend rearwardly of the rear plane 38; the corkscrew 22 may tangentially intersect the rear plane 38, but does not extend through the rear plane 38. With the locking arm 30 in the closed position, the locking arm 30 is parallel with, and spaced slightly rearwardly from, the rear plane 38. In the preferred embodiment, the hook 10 includes a circular cross-section. As such, the plane 38 intersects the rear-most tangent of both the upper span 24 and the lower span 26 and only tangentially intersects the corkscrew 22.

A method of using the fishing hook 10 described herein includes the following steps:

(a) moving the locking arm 30 to the open position;

(b) wrapping a worm 40 around the corkscrew 22;

(c) moving the locking arm 30 to the closed position by joining the clasp 34 to the lower span 26; and

(d) one end of the worm 40 is then optionally skewered on the hook 16, to make the hook a “weedless hook.”

The final step (d) is optional. One improvement of the fishing hook 10 described herein is that the fishing hook 10 can be baited without the need to pierce the worm 40 with the hook 16. Removing the need to pierce the worm 40 can make fishing more accessible to new users who may otherwise be put off by having to bait a hook by piercing the worm 40 with the hook. When utilitzing step (d), the hook 10 become a weedless hook since the hook 16 will be guarded by the worm 40 such that when the hook 10 is moved through weeds the hook 16 is less likely to snag on the weeds.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A fishing hook comprising:
a J-shaped body extending from an eyelet at a first end to a hook at a second end;
a corkscrew is positioned intermediately between the first end and the second end;
a locking arm is joined by a hinge to an upper span, the upper span is defined as a portion of the J-shaped body spaced between the corkscrew and the eyelet, the locking arm includes a clasp for removably grasping a lower span, the lower span defined as a portion of the J-shaped body spaced between the corkscrew and the hook, the locking arm includes a barb extending toward the corkscrew; the corkscrew is positioned forwardly of a rear plane defined by the rear-most edges of both the upper span and the lower span.

2. A fishing hook comprising:
a J-shaped body extending from an eyelet at a first end to a hook at a second end;
a corkscrew is positioned intermediately between the first end and the second end;
a locking arm is joined by a hinge to an upper span, the upper span defined as a portion of the J-shaped body spaced between the corkscrew and the eyelet.

3. The fishing hook of claim 2, wherein the locking arm includes a clasp for removably grasping a lower span, the lower span defined as a portion of the J-shaped body spaced between the corkscrew and the hook.

4. The fishing hook of claim 3, wherein the locking arm includes a barb extending toward the corkscrew.

5. The fishing hook of claim 4, wherein the corkscrew is positioned forwardly of a rear plane defined by the rear-most edges of both the upper span and the lower span.

6. A fishing hook comprising:
a J-shaped body extending from an eyelet at a first end to a hook at a second end;
a corkscrew is positioned intermediately between the first end and the second end.

7. The fishing hook of claim 6, further comprising: a locking arm joined by a hinge to an upper span, the upper span is defined as a portion of the J-shaped body spaced between the corkscrew and the eyelet.

8. The fishing hook of claim 7, wherein the locking arm includes a clasp for removably grasping a lower span, the lower span defined as a portion of the J-shaped body spaced between the corkscrew and the hook.

9. The fishing hook of claim 8, wherein the locking arm includes a barb extending toward the corkscrew.

10. The fishing hook of claim 9, wherein the corkscrew is positioned forwardly of a rear plane defined by the rear-most edges of both the upper span and the lower span.
